(19) United States
(12) Patent Application Publication
(10) Pub. No.: US 2025/0245422 A1
(43) Pub. Date: Jul. 31, 2025

(54) MULTI-INPUT BASED CONTENT CREATION SYSTEM AND METHOD

(71) Applicant: BOLD Limited, Hamilton (BM)

(72) Inventors: Kompal CHAUDHARY, Noida (IN); Rohit GARG, Ghaziabad (IN); Mohit Kumar GOEL, Noida (IN); Harshit KAUTHS, Delhi (IN)

(21) Appl. No.: 18/428,970

(22) Filed: Jan. 31, 2024

(51) Int. Cl. G06F 40/166; G06F 40/30; G06Q 10/1053

(52) U.S. Cl. CPC G06F 40/166; G06F 40/30; G06Q 10/1053

(57) ABSTRACT

A method for generating a résumé may receive at least an experience parameter and a job title parameter. Related job titles in a historical résumé dataset may be selected that are semantically related to the job title parameter by using a semantically similar job title selector. The historical résumé dataset may be filtered based on at least the experience parameter and the related job titles to obtain a filtered résumé dataset. A list of user skills may be obtained by selecting skills from the filtered résumé dataset. A list of curated skills may be obtained by selecting curated skills from a curated skills dataset based on at least the experience parameter and the one or more related job titles. A list of candidate skills may be obtained by mapping skills from the list of user skills to corresponding curated skills. Selected candidate skills may be incorporated into a résumé.

### BACKGROUND

### Field

Aspects of the present disclosure relate to artificial intelligence (AI)-based content creation, and more particularly to a multi-input based content creation system and method for creating résumé content.

### Description of Related Art

Employers, employment agencies, and the like, may receive thousands of résumés or curricula vitae (CVs) for any given job opening. In order to deal with the large volume of applicants, human resource departments may resort to using résumé parsing software to search résumés for keywords and phrases that are indicative of desired skills and experience, thus reducing the number of résumés, and applicants, that a hiring manager will need to review and potentially interview. While such parsing software reduces an impractical task to a practical task, they generally fail to account for the fact that different applicants may use different phrasing to describe their individual skills and/or non-standard job titles. Consequently, conventional résumé parsers may reject résumés of applicants that are actually highly qualified for the job. In many cases, this technical deficiency is based on the lack of matching keywords in the rejected résumés. While attempts have been made to adjust résumé parsers to match keywords to a range of similar terms, little has been done on the résumé creation side to address this problem.

Therefore, a need exists for résumé content creation tools that both accurately express an individual's skills and work experience and also create résumé content that is amenable to résumé parsing software.

### SUMMARY

Certain aspects provide a method for generating a résumé. The method may include receiving at least an experience parameter and a job title parameter from a user interface. The method may also include identifying, using a semantically similar job title selector, one or more related job titles in a historical résumé dataset that are semantically related to the job title parameter. The method may furthermore include filtering the historical résumé dataset based on at least the experience parameter and the one or more related job titles to obtain a filtered résumé dataset. The method may in addition include selecting one or more skills from the filtered résumé dataset to obtain a list of user skills. The method may moreover include selecting one or more curated skills from a curated skills dataset based on at least the experience parameter and the one or more related job titles to obtain a list of curated skills. The method may also include mapping individual skills from the list of user skills to corresponding curated skills of the list of curated skills to obtain a list of candidate skills from among the list of curated skills. The method may furthermore include incorporating one or more candidate skills, selected from the list of candidate skills, into a résumé document using a résumé builder user interface.

Certain aspects provide another method for generating a résumé. The method may include presenting a user interface having one or more input fields, and one or more output fields. The method may also include receiving at least an experience parameter and a job title parameter at the one or more input fields of the user interface. The method may furthermore include transmitting the experience parameter and the job title parameter to a résumé generating service. The method may in addition include outputting a list of candidate skills in the one or more output fields of the user interface, the list of candidate skills corresponding to curated skills filtered from a curated skills dataset based on an experience range derived from the experience parameter, and one or more related job titles extracted from a historical résumé dataset, the one or more related job titles being identified as semantically related to the job title parameter. The method may moreover include detecting at least one user action, at the user interface, configured to indicate one or more selected candidate skills selected from the list of candidate skills presented in the one or more output fields. Method may also include transmitting the one or more selected candidate skills to the résumé generating service. The method may furthermore include outputting a résumé document at the user interface, the résumé document being generated based on the one or more selected candidate skills.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example user interface for generating a résumé in accordance with aspects of the present disclosure.

FIG. 2 depicts a process implemented by a processing system for generating a résumé in accordance with aspects of the present disclosure.

FIG. 3 depicts a flow diagram for generating a résumé in accordance with aspects of the present disclosure.

FIG. 4 depicts another flow diagram for generating a résumé in accordance with aspects of the present disclosure.

FIG. 5 depicts a processing system configured to implement aspects of the present disclosure.

FIG. 6 depicts an example user interface for generating a résumé in accordance with aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

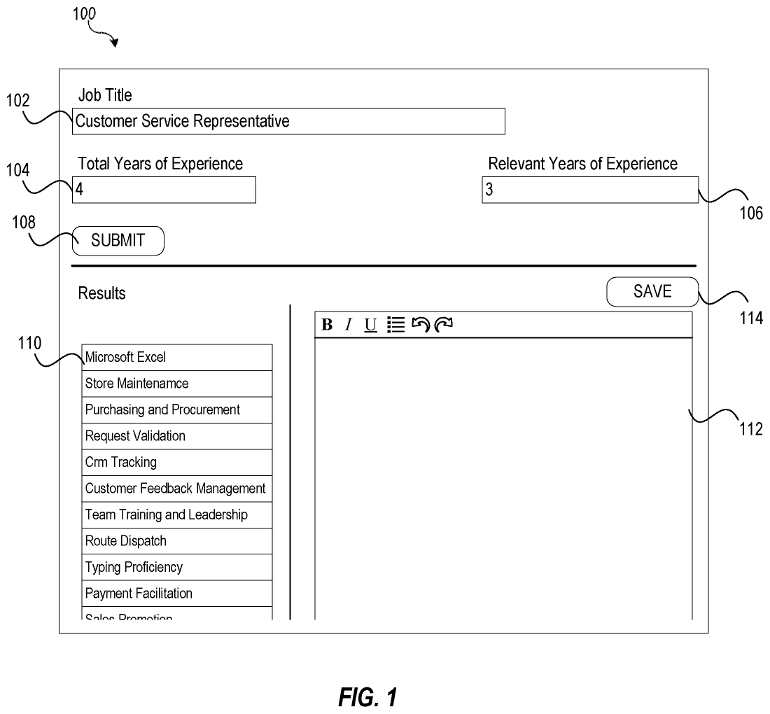

Aspects of the present disclosure provide apparatuses, methods, processing systems, and computer-readable mediums for generating résumé content (e.g., skills) suggestions tailored to an individual user using multiple inputs, such as years of experience and current job title. Aspects of the present disclosure include providing a user interface, for example, the user interface (UI) 100 shown in FIG. 1, which allows an individual to enter multiple employment related criteria (also referred to herein as inputs), such as years of experience and current job title. While only the inputs for years of experience and job title are shown in FIG. 1, and referenced throughout the present disclosure as examples, aspects of the present disclosure are not limited to only these inputs. Instead, other or additional inputs may be used as appropriate, such as past job titles, education level, degree attained, area of study, employer, industry, occupation, and the like, along with content selections by other users with similar interests.

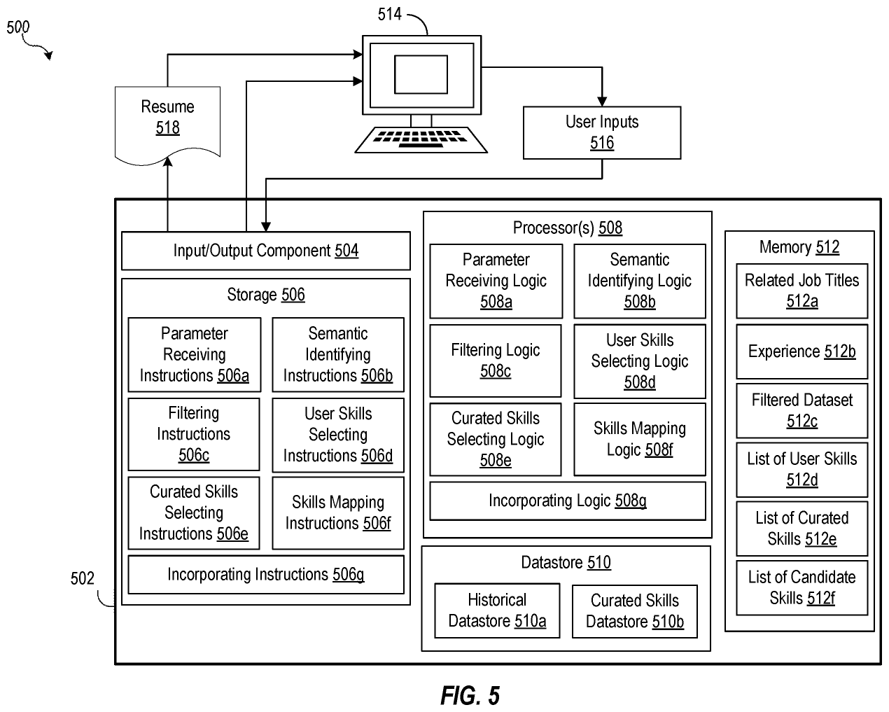

As above, aspects of the present disclosure may allow a user to indicate inputs, such as a job title and years of experience, to the résumé creation system (e.g., processing system 502 shown in FIG. 5). The résumé creation system identifies similar job titles in a database of historical résumés. Based on the similar job titles, relevant job skills are extracted from a skills database, and displayed to the user. The user can select skills to include in a new résumé. By providing the user with relevant job skills from the skills database, the user can be more confident that the skills terminology and description will be properly interpreted by résumé parsing software, and passed through parsing filters.

Employers and hiring managers are often inundated with résumés—such as when applicants are solicited for a new job opening, but also during periods leading up to an end of school term when a large number of individuals, having just received a degree from a university/college or certification from, for example a trade school, are looking to enter the workforce. In both cases, the number of résumés received often makes it impractical for an individual or department to evaluate each résumé and determine which applicants should be invited to interview.

Often, the hiring individual may only have enough time to perform a cursory scan of the résumé. The time pressure to review and approve or reject a résumé for a follow-up interview can lead to applicants being rejected based on unconscious biases. These biases may manifest based on an applicant's name, for example, but may also arise from the status of an applicant's current employer, the length of the current unemployment period, or the prestige of the school attended by the applicant. Some of these biases can lead to liability issues under Equal Employment Opportunity Commission laws. Thus, résumé parsing software is employed to avoid unintended biases and expedite the process of winnowing down a large number of résumés to a few that satisfy certain job-related criteria. For example, the résumé parsing software may be configured to scan a résumé for particular terms and phrases (e.g., filters) that the hiring manager has determined are representative of the position being offered. The filters may include particular job skills or tasks that are required for the position. For example, an individual applying for a technical support position may be required to have experience with certain software packages or the ability to troubleshoot and repair electronic devices. The number of filters used by the résumé parsing software can determine the number of résumés that are allowed to pass to the next round, e.g., interviews. Résumés evaluated by the résumé parsing software need to match one or more of the filters in order to pass to the next round. However, the résumé parsing software may not include all variations in which a particular skill can be phrased, thus some qualified applicants may be rejected.

Aspects of the present disclosure address the above flaw in résumé parsing software. Aspects of the present disclosure provide a user with a list of curated job skills matched against a list of job skills culled from a database of historical résumés based on multiple inputs (e.g., job title and experience level). The curated job skills are expressed in terms and phrasing that occur most often in résumé parsing software; thus, the use of any of the curated job skills will increase the chances that the résumé will pass the résumé parsing software. In addition to providing a list of curated job skills, aspect of the present disclosure also orders the curated skills based on the prevalence of similar job skill terms appearing in the historical résumés for the given inputs. As a result, the user can select curated job skills that most closely match the user's actual skills and are most prevalent in résumés from other applicants with a similar job title and experience level. Because the résumé created using aspects of the present disclosure uses the most prevalent phrasing for job skills, the likelihood of the résumé passing the filters of the résumé parsing software can be greatly increased.

Present disclosure employs one or more computer systems specially configured to perform processes and methodologies, such as those described below, to realize aspects of the present disclosure. For example, an aspect of the present disclosure utilizes a computer system implementing a natural language processing model, such as stsb roberta-large, to encode the job titles. Additionally, the computer systems may implement a similarity determining function, such as a Cosine similarity function, and use the job title encodings to identify semantically similar job titles. Moreover, various databases are constructed, and structured, to hold historical résumé data, and curated job skills in a form that is readily retrievable and useable by aspects of the present disclosure.

### Example User Interface

FIG. 1 depicts an example user interface (UI) 100 provided by a processing system implementing aspects of the present disclosure, such as processing system 502 shown in FIG. 5. The UI 100 shown in FIG. 1 is a graphical user interface (GUI), however in the context of the present disclosure, it is understood that the UI 100 is not limited to a GUI, but rather may be implemented in other forms, such as spoken prompts, for example, which may be advantageous for users that are visually impaired. For brevity, the present disclosure will focus on a GUI version of the UI 100.

The UI 100 includes a plurality of interactive elements, such as text input fields, drop-down menus, text edit fields, buttons, and the like. In particular, UI 100, in certain embodiments, presents a job title field 102 configured to receive a job title from a user. A second text input field may be presented as a total years of experience field 104. In certain embodiments, another text input field may be presented as a relevant years of experience field 106. In other embodiments, relevant years of experience field 106 is present on the UI 100, but not the total years of experience field 104. Total years of experience may signify the total working years of the individual, while relevant years of experience may be limited to the number of years the individual has held the job title entered in the job title field 102. In certain embodiments, the total years of experience field 104 and the relevant years of experience field 106 may be configured to receive only numerical entries while the job title field 102 may be configured to receive any string characters. Other embodiments, may include additional text input fields, such as one or more of the following: highest degree completed, degree major, previous job title, recent graduate, career changer, employment gap, employer, industry, occupation, and the like, along with content selections by other users with similar interests.

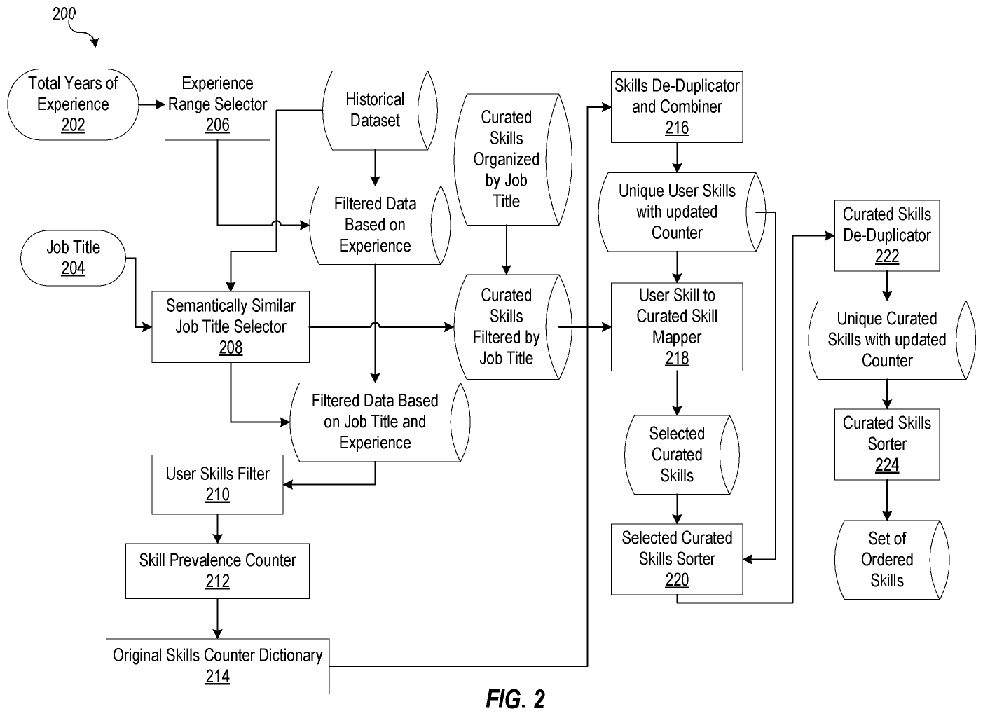

A submit button 108 may be provided that, when actuated by the user, causes underlying instruction code to transmit text entered in the job title field 102, total years of experience field 104, and/or relevant years of experience field 106 to a processing system, such as processing system 502 shown in FIG. 5. The actions performed by the processing system 502 are described in detail below with respect to FIG. 2.

The UI 100 receives, for example, from the processing system 502, a set of results, namely a list of relevant job skills, generated based on the information entered in the job title field 102, total years of experience field 104 and/or relevant years of experience field 106, as well as information entered in any other text input field. The list of job skills may be displayed in a text list box 110. Additionally, user selection of a job skill from the list of job skills displayed in the text list box 110, in some embodiments, causes a skill description of the selected job skill to be displayed in text edit region 112. The skill description may include tasks, for example, that utilized the selected job skill. Within the text edit region 112, the user is provided with the functionality to edit the text of the skill description to better reflect the user's actual skills and experience. Selected job skills, along with any edits made by the user may be saved to a database by actuating a “Save” button 114.

In some embodiments, the saved job skills are associated in the database with the job title provided in the job title field 102. Subsequent to a user selecting and saving job skills, the processing system 502 may be instructed by the user through additional UI screens (not shown) to generate a résumé incorporating the job title entered in the job title field 102 along with the associated job skills.

### Example Process

FIG. 2 depicts an example block representation of a process 200 performed by a backend processing system, such as the processing system 502 shown in FIG. 5. For brevity, the process 200 is described receiving two inputs from the UI 100 shown in FIG. 1, namely total years of experience and job title. However, as noted above, other and/or additional information can be provided to the processing system 502 and processed by the process 200 described herein.

The process 200 receives a value for total years of experience at block 202, and a job title at block 204. The total years of experience is used by an experience range selector 206 of the process 200 to select an appropriate experience range. For example, someone just entering the workforce with no experience may have entered zero for total years of experience. In such a case, the experience range selector 206 may select an experience range of 0-2 years. On the other hand, for someone with 20 years of experience, the experience range selector 206 may select an experience range of 15-25 years.

While the submitted years of experience can be used in certain embodiments of the present disclosure, application of an experience range to aspects of the present disclosure can provide some benefits. An experience range, as will be described below, when selected appropriately, can provide a broader, but still relevant, list of skills that an individual can add to their résumé. For example, cashier with 4 years of experience, may still perform job tasks that may be considered a job skill of a cashier with one year of experience. Conversely, a cashier with 2 years of experience, depending on the individual and employer, may be performing some of the tasks that normally a retail employee having 4 or 5 years of experience may perform, such as training new cashiers or performing some managerial tasks. Thus, by using an experience range there is a better chance of capturing and presenting to the user a full range of skills that may be appropriate for the experience level.

Moreover, in some embodiments the experience range selector 206 may base the selection of experience range on, not just the total years of experience, but also on the job title received at block 204. For example, certain professions require significant on-the-job-training, thus someone with 5 years of experience may still be considered a novice, and thus the experience range selector 206 may select an experience range of 0-7 years in this case. The experience ranges disclosed above are intended for illustrative purposes only, and are not intended to provide definitive ranges. The experience ranges may be any ranges deemed appropriate based on the particular implementation of aspects of the present disclosure.

A semantically similar job title selector 208 of the process 200 uses the job title provided at block 204 to identify and select semantically similar job titles from a historical dataset of résumés. Various methodologies may be applied by the semantically similar job title selector 208 to identify semantically similar job titles, for example certain embodiments of the present disclosure may apply a Cosine similarity function:

$$Similarity Score ( S ) = cos ( ⌀ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} , \qquad ( Eq . 1 )$$

where Aᵢ and Bᵢ are the ith component of n-dimensional vectors A and B, and θ represents the degree of similarity as an angle between vectors A and B, which represent vector embeddings of job titles. Alternatively, word2vec, GloVe, Google Similarity Distance, or other natural language processing (NLP) methods for determining semantic similarity may be used, as well.

The similarity score (S) is calculated using the Cosine similarity between the encodings of two statements (e.g., the user-provided job title (A) and a job title from the historical dataset of résumés (B)). The encodings, generally represented as n-dimensional vectors, are generated using any appropriate natural language processing (NLP) model, such as stsb-roberta-large, paraphrase-mpnet-base, gtr-t5-large or other sentence transformer models. In certain embodiments, the historical dataset of résumés may be implemented as a database in which each historical job title may be associated with an encoding generated by the NLP. In certain embodiments, the database stores the dataset in a comma separated values (CVS) file.

The semantically similar job title selector 208 applies a similarity threshold for the similarity scores to determine which job titles are semantically similar enough to be selected. For example, the similarity threshold may, in certain embodiments, be set at 0.75 (or 75%) similarity. Other similarity threshold values, such as 0.65, 0.70, 0.80, 0.85, 0.90, or similar, may be used as deemed appropriate. However, a similarity threshold value that is too permissive may allow job titles that are not relevant, while an overly restrictive similarity threshold may exclude relevant job titles and thus limit the set of job skills presented to the user. Any job title above this similarity threshold is selected by the semantically similar job title selector 208.

For example, identifying similar job titles to “Cashier” might yield a list of [‘Checkout Operator’, ‘Cashier Clerk’, ‘Cashier Attendant’, ‘Point of Sale (POS) Operator’, ‘Cash Handler’, ‘Store Cashier’] for a similarity threshold set to 0.75. If the similarity threshold value is set to 0.9, the resulting list may be [‘Cashier Clerk’, ‘Cashier Attendant’, ‘Cash Handler’, ‘Store Cashier’] instead. However, with the threshold is set to 0.6, the list could add extra job titles not directly matching to “Cashier”, such as [‘Retail Clerk’, ‘Sales Associate’, ‘Checkout Operator’, ‘Cashier Clerk’, ‘Customer Service Representative’, ‘Front End Associate’, ‘Cashier Attendant’, ‘Point of Sale (POS) Operator’, ‘Cash Handler’, ‘Store Cashier’]. During the course of development and experimentation a similarity threshold value of 0.75 was identified as providing an optimal result.

The historical dataset of résumés is filtered by the process 200, first based on the experience range selected by the experience range selector 206 to obtain filtered data based on experience, and further filtered by the semantically similar job titles selected by the semantically similar job title selector 208. To facilitate filtering of the data in the historical dataset of résumés, the historical dataset may be implemented as a database that includes fields, such as job title, skills, years of experience, and the like. Filtering such a database may be accomplished using database query languages (e.g., SQL, XQuery, GraphQL, and the like), for example. The resultant data, e.g., filtered data based on job title and experience, is further filtered by a user skill filter 210 to extract a list of user skills for the semantically similar job titles within the selected experience range.

For example, the user skills filter 210 may extract skills associated with the semantically similar job titles from the historical dataset in the same manner as described above with respect to filtering the historical dataset based on job title and experience. Alternatively, a separate database of skills may be employed by the user skills filter 210. The database of skills may have predefined job titles associated with one or more skills. Thus, the user skills filter 210 may select skills that are associated with semantically similar job titles in the database of skills. Other filtering techniques may be employed as appropriate without deviating from aspects of the present disclosure.

A skill prevalence counter 212 tracks prevalence (e.g., occurrence) of each user skill within the historical dataset. An original skills counter dictionary 214 is generated based on the skill prevalence counter 212. The original skills counter dictionary 214 provides a listing of all the user skills extracted by the user skills filter 210 along with their associated prevalence count generated by the skill prevalence counter 212.

For example, if a user specifies “Cashier” as their job title, a corresponding original skills counter dictionary 214 is established to consolidate skills prevalent among other users with the same job title in their résumés. The original skills counter dictionary 214 might take the form: {‘Deposit Verification’: 10, ‘Wire Transfers’: 9, ‘Stocking And Replenishing’: 7, ‘Merchandising’: 5}. In this representation, the counts signify the frequency of each skill, indicating that “Deposit Verification” is employed by 10 users, “Wire Transfers” by 9 users, and so on.

Moreover, the semantically similar job titles are used by the process 200 to filter a database of curated skills organized by job title to obtain curated skills filtered by the job title provided in block 204. The database of curated skills is a database containing skills generated and maintained by a content creation system implementing aspects of the present disclosure. Filtering the database of curated skills may be accomplished using database query languages (e.g., SQL, XQuery, GraphQL, and the like), for example. In certain embodiment, the content creation system may be a résumé creation service. The historical dataset of résumés, in contrast is a database of actual user résumés that have been created or uploaded to the résumé creation service and thus represent a real world relationship between job titles, experience level and job skills.

A skills de-duplicator and combiner 216 parses the original skills dictionary to identify duplicate skills and combine the duplicates into a unique entry. The skills de-duplicator and combiner 216 further performs a summation of the prevalence counts of the duplicate skills and updates the prevalence count for the unique entry of the skill. The de-duplicated and combined user skills form a unique user skills dataset.

A user skill to curated skill mapper 218 maps the skills of the unique user skills dataset to the curated skills filtered by the semantically similar job titles to generate a selected curated skills dataset. The user skill to curated skill mapper 218 may employ various mapping techniques to map the user skills to the curated skills, for example text matching, natural language processing (NLP), semantic similarity, rulesets, fuzzy logic, or other appropriate text mapping technique. The curated skills dataset includes prevalence counts associated with the mapped user skills. A selected curated skills sorter 220 sorts the selected curated skills into a hierarchy based on the associated prevalence count of each curated skill.

A curated skills de-duplicator and combiner 222 parses the sorted curated skills to identify duplicate skills and combine the duplicates into a unique entry. The curated skills de-duplicator and combiner 222 further perform a summation of the prevalence counts of the duplicate skills and updates the prevalence count for the unique entry of the curated skill. The de-duplicated and combined curated skills form a unique curated skills dataset. A curated skills sorter 224 sorts the unique curated skills dataset based on the prevalence count and outputs a set of ordered skills.

The set of order skills may, in some embodiments, be transmitted to a user workstation, such as workstation 514 shown in FIG. 5, and displayed in a text list box, such as text list box 110 shown in FIG. 1.

### Example Methods

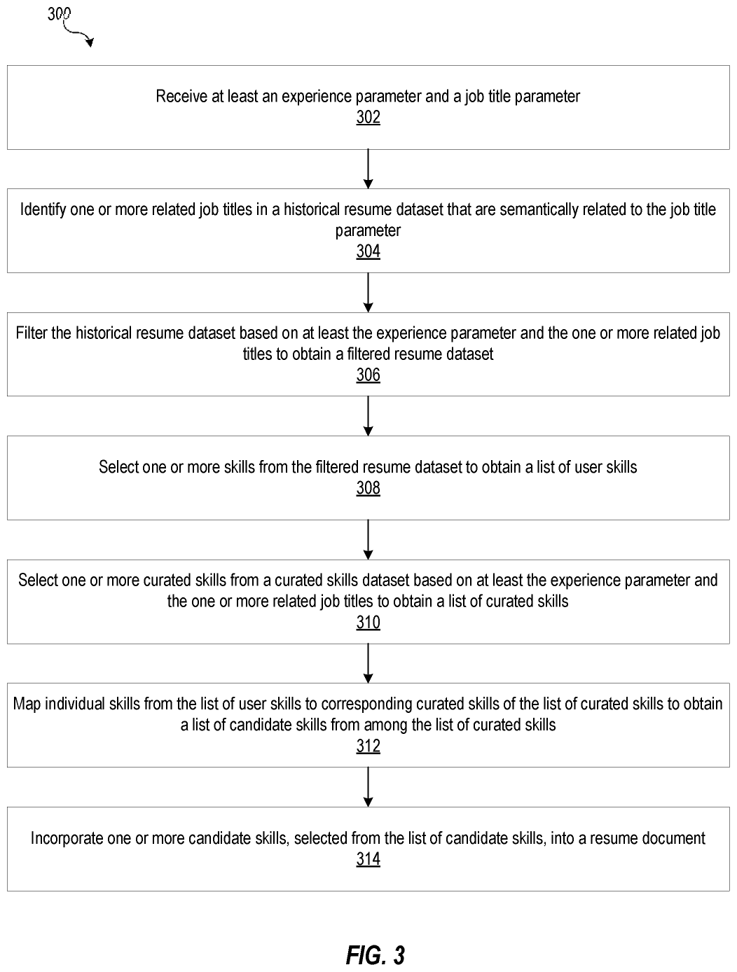

FIG. 3 depicts a method 300 for generating a résumé in accordance with aspects of the present disclosure. In certain embodiments, the method 300 is performed by a processing system, such as the processing system 502 shown in FIG. 5.

The method 300 begins at block 302 with receiving at least an experience parameter and a job title parameter. The experience parameter may be a total years of experience value, and job title parameter may be a job title, both submitted by a user through UI 100 shown in FIG. 1 and described above. In some examples, these parameters may be received by a parameter receiving logic, such as 508a of FIG. 5.

Proceeding to block 304, the method 300 identifies one or more related job titles in a historical résumé dataset that are semantically related to the job title parameter. In some examples, identifying the semantically related job titles may be implemented by semantic identifying logic, such as 508b of FIG. 5. As described above, semantically similar job titles may be identified using a cosine similarity function represented by Eq. 1 and selected using a similarity threshold value. In certain embodiments, the historical résumé dataset includes historical résumés that are at least 80% complete, and have been downloaded at least once. Moreover, the historical résumé dataset may be compiled from historical résumés spanning a defined period of time. In certain embodiments, a sliding time window having a period of between 1 year and 3 years may be implemented as the defined period of time for the historical résumé dataset. The period for the sliding time window can be of any appropriate duration. However, an overly narrow window risks having too few historical résumés to sample, while an overbroad window can result in outdated job titles and skills. Furthermore, an overbroad window can also impact responsiveness and resource usage.

The method 300 next proceeds to block 306 with filtering the historical résumé dataset based on at least the experience parameter and the one or more related job titles to obtain a filtered résumé dataset. In some examples, the historic résumé dataset is filtered by filtering logic, such as 508c of FIG. 5.

The method 300 then proceeds to block 308 with selecting one or more skills from the filtered résumé dataset to obtain a list of user skills. In some examples, the one or more skills may be selected by a user skills selecting logic, such as 508d of FIG. 5. In certain embodiments, the method 300 generates a count dictionary for each user skill reflecting occurrences of each respective user skill in the historical résumé dataset.

At block 310, the method 300 continues with selecting one or more curated skills from a curated skills dataset based on at least the experience parameter and the one or more related job titles to obtain a list of curated skills. In some examples, the one or more curated skills may be selected by a curated skills selecting logic, such as 508e of FIG. 5. The method 300, in certain embodiments, may sort the one or more curated skills in the list of curated skills based on the count dictionary associated with each user skill in the list of user skills and a semantic similarity score indicative of semantic similarity between each of the related job titles and the job title parameter.

The method 300 continues to block 312 with mapping individual skills from the list of user skills to corresponding curated skills of the list of curated skills to obtain a list of candidate skills from among the list of curated skills. In some examples, the user skills may be mapped to curated skills by a skills mapping logic, such as 508f of FIG. 5. The skills mapping may be performed using any appropriate mapping technique, such as text matching, NLP, semantic similarity, rulesets, fuzzy logic, and the like. Additionally, the method 300, in certain embodiments, may arrange the list of candidate skills as an ordered list based on the count dictionary associated with each respective candidate skill. The method 300 may include preparing the list of candidate skills for presentation on a user interface. Additionally, the method 300 may receive, from the user interface, the one or more candidate skills selected from the list of candidate skills, by the user.

The method 300 ends at block 314 with incorporating one or more candidate skills, selected from the list of candidate skills, into a résumé document. In some examples, the selected candidate skills may be incorporated into a résumé document by an incorporating logic, such as 508g of FIG. 5.

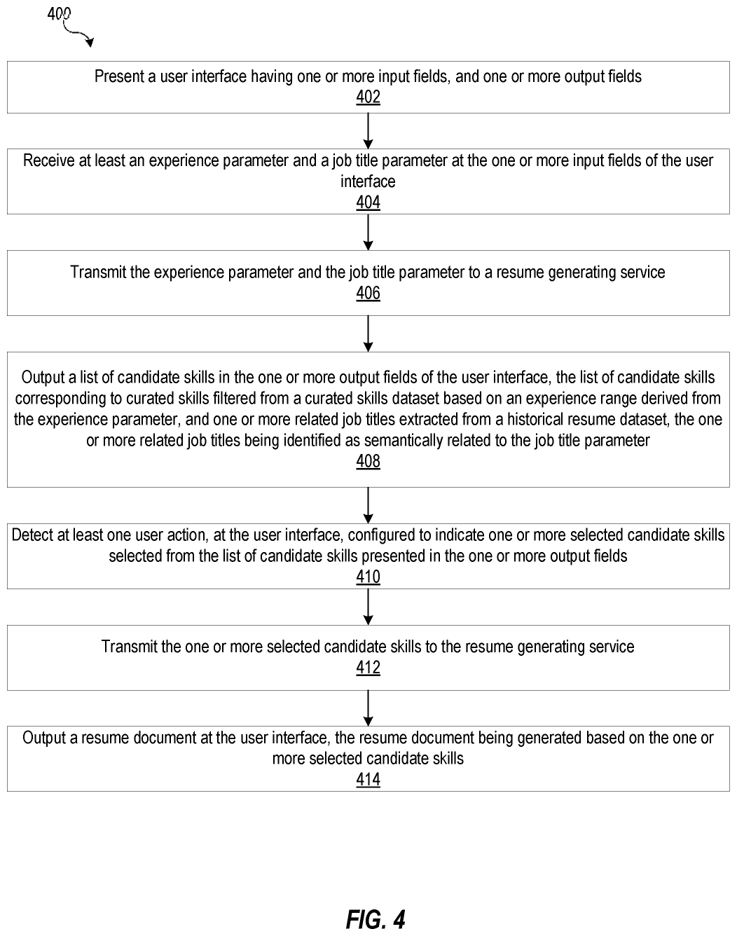

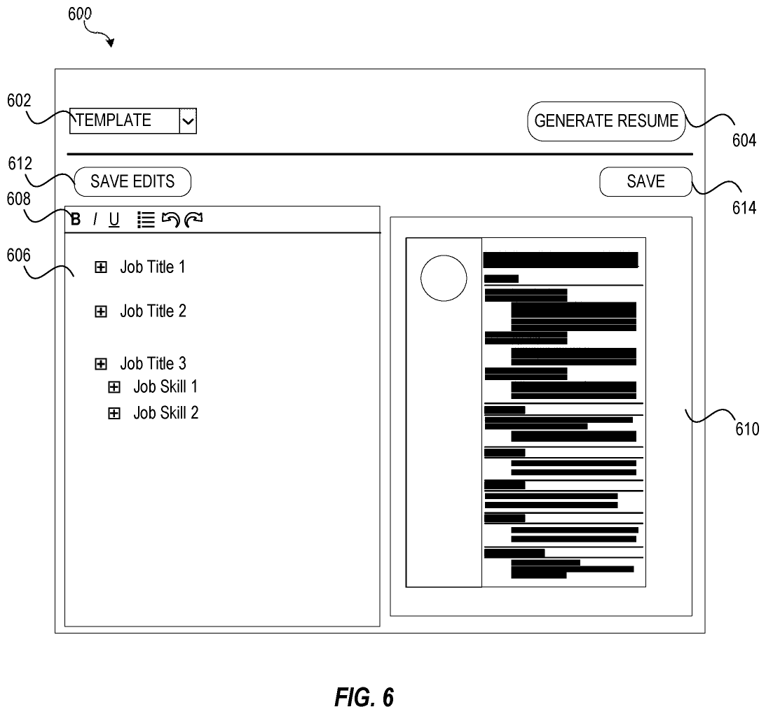

For example, selected candidate skills may be grouped together and associated with the job title originally submitted by the user as shown in the UI 600 shown in FIG. 6. The user may be given additional opportunities, by way of iterative application of aspects of the present disclosure, such as process 200 of FIG. 2, method 300 of FIG. 3 or method 400 of FIG. 4. In each iteration, the user may submit a new job title and relevant years of experience, for example. The new job title may be of a position held prior to the previously submitted job title. An updated list of candidate skills may be displayed to, and selected by, the user. Upon completion of the iterative process, the user may actuate a UI element to initiate a process by which the content creation system combines the stored job skills and job titles into a structured document for the user's review. The structured document may be presented in UI 600.

As shown in FIG. 6 UI 600 includes a button 604 configured to generate a résumé based on a template selected from an interactive element, such as a drop-down list box 602. The résumé content is output to an output element, such as text edit box 606. The résumé content may be organized in a tree structure with each job title representing a branch and associated job skills represented as leaves. The text edit box 606 may provide text editing tools 608, allowing the user to modify the text, add additional information, such as employment dates and the like, and rearrange the content. Additionally, the UI 600 may provide a preview pane 610 in which the résumé content shown in the text edit box 606 is displayed with the selected template applied thereto. Edits made to the résumé content in the text edit box 606 may, in certain embodiments, be reflected in the preview pane 610. A save edits button 612 is configured to save changes made to the résumé content shown in the text edit box 606, and a second save button 614 is configured to save the résumé with the applied template shown in preview pane 610 as a résumé document. The résumé document may be saved in any appropriate document format, such as PDF, DOCX, ODF, SVG, JPEG, and the like.

Note that FIG. 3 is just one example of a method, and other methods including fewer, additional, or alternative steps are possible consistent with this disclosure.

FIG. 4 depicts a method 400 for generating a résumé in accordance with aspects of the present disclosure. In certain embodiments, the method 400 is performed by a user workstation, such as the workstation 514 shown in FIG. 5.

The method 400 begins at block 402 with presenting a user interface, such as UI 100 shown in FIG. 1 and described above, having one or more input fields (e.g., text input fields 102, 104, 106, and text edit region 112 shown in FIG. 1), and one or more output fields (e.g., text list box 110 shown in FIG. 1, and text edit region 112).

The method 400 proceeds to block 404 with receiving at least an experience parameter and a job title parameter at the one or more input fields of the user interface. In some examples, the job title parameter may be received at a job title field, such as 102 of FIG. 1, and the experience parameter may be received at an experience field, such as total years of experience field 104 or relevant years of experience 106 of FIG. 1.

The method 400 next proceeds to block 406 with transmitting the experience parameter and the job title parameter to a content creation system, such as 502 of FIG. 5. In some examples, transmitting the experience parameter and the job title parameter may be initiated by actuating a button UI element, such as 108 of FIG. 1.

The method 400 continues onto block 408 with outputting a list of candidate skills in the one or more output fields of the user interface, such as the text list box 110 in FIG. 1. In certain embodiments, the list of candidate skills corresponds to curated skills filtered from a curated skills dataset based on an experience range derived from the experience parameter, and one or more related job titles extracted from a historical résumé dataset. The one or more related job titles may be identified as semantically related to the job title parameter. In certain embodiments, each of the one or more related job titles have a similarity score, based on a calculated Cosine similarity between each of the one or more related job titles and the job title parameter, exceeding a threshold value. In certain embodiments, the one or more skills in the list of candidate skills may be sorted based on an occurrence count for each of the one or more candidate skills reflecting a number of occurrences of the respective skill in the historical résumé dataset and a similarity score indicative of a semantic similarity between each of the one or more related job titles and the job title parameter.

The method 400 proceeds to block 410 with detecting at least one user action, at the user interface, configured to indicate one or more selected candidate skills selected from the list of candidate skills presented in the one or more output fields.

The method 400 continues to block 412 with transmitting the one or more selected candidate skills to the résumé generating service.

The method 400 ends at block 414 with outputting a résumé document at the user interface. The résumé document may be generated based on the one or more selected candidate skills.

In certain embodiments, the method 400 instructs the workstation 514 to present a set of graphical layout templates, and accept a selection of a graphical layout template from among the set of graphical layout templates. The résumé document may be output with the graphical layout template applied thereto. In certain embodiments, outputting the résumé document may include presenting a visual representation of the résumé document in a preview area of the user interface. Outputting the résumé document may also include implementing an interactive element on the user interface configured to download the résumé document.

### Example Processing System

FIG. 5 depicts an example computing environment 500 in which aspects of the present disclosure may be implemented. As shown, the computing environment 500 may include a processing system 502 and a user workstation 514. The processing system 502 may be implemented as a desktop computer, server, mainframe, distributed computer architecture, cloud services, or the like. In certain embodiments, the processing system 502 may operate as a résumé generating system. In other embodiments, the processing system 502 may operate as one component of a résumé generating system.

The user workstation 514, in certain embodiments, may be co-located with, and in communication with the processing system 502 via a local area network (LAN). In other embodiments, the user workstation 514 may be remotely located with respect to the processing system 502, and communication between the user workstation 514 and the processing system 502 may be implemented via the Internet, a wide area network, or the like. The user workstation 514 may be any of a desktop computer system, notebook computer, tablet device, mobile phone device, or the like.

The processing system 502 may include an input/output (I/O) component 504, such as a network interface and associated computer-readable instructions (e.g., firmware) for facilitating communication between the processing system 502 and external devices, such as the user workstation 514, external storage, printers, etc. The I/O component 504 is configured to receive user inputs 516 from the user workstation 514, and transmit résumé related data to the user workstation 514.

The processing system 502 may also include one or more storage devices 506 (also referenced as storage 506), one or more processors, collectively referenced as processor 508, a datastore 510, and memory 512.

Processor(s) 508 are generally configured to retrieve and execute instructions stored in one or more storage 506, including local hard disk drives, solid-state storage devices optical storage devices, and the like. Similarly, processor(s) 508 are configured to retrieve and store application data residing in the storage 506. In certain embodiments, processor(s) 508 are included to be representative of a one or more central processing units (CPUs), graphics processing unit (GPUs), tensor processing unit (TPUs), accelerators, field programmable gate arrays (FPGAs), and other processing devices.

The memory 512 can be random access memory (RAM), flash memory, and similar volatile and non-volatile storage. In certain embodiments, the memory may be utilized as a RAM disk such that the memory is treated by the processing system as a storage device, and thus may be considered within the context of the present disclosure as a component of storage 506. In FIG. 5 a distinction is made between computer-readable instructions 506a-506g held in storage 506 and the data held in memory 512. However, in practical operation, memory 512 and storage 506 can interchangeably hold both computer-readable instructions 506a-506g and data 512a-512f.

The storage 506 implements computer-readable storage for storing computer-readable instructions configured for implementing, by the processor 508, methods embodying aspects of the present disclosure, such as method 300 shown in FIG. 3, and method 400 shown in FIG. 4, as well as process 200 shown in FIG. 2. In particular, the storage 506 includes parameter receiving instructions 506a, semantic identifying instructions 506b, filtering instructions 506c, user skills selecting instructions 506d, curated skills selecting instructions 506e, skills mapping instructions 506f, and incorporating instructions 506g.

The parameter receiving instructions 506a interact with parameter receiving logic 508a of the processor 508 and the I/O component 504 to perform block 302 shown in FIG. 3, for example, such that the processing system 502 receives user inputs 516 from the user workstation 514. The user inputs 516 may include a job title parameter and an experience parameter entered by a user on a user interface, such as UI 100 shown in FIG. 1. The experience parameter may, in certain embodiments, be converted to an experience range. The experience range may be stored in memory as experience 512b.

The semantic identifying instructions 506b interact with semantic identifying logic 508b of the processor 508 to perform block 304 of FIG. 3, for example. The semantic identifying instructions 506b causes the processor 508 to access a historical datastore 510a (e.g., historical résumé datastore) of datastore 510, and identify one or more historical job titles that are semantically similar to the job title parameter. The semantically similar job titles are identified based on a similarity score calculated using, for example, a Cosine similarity function (e.g., Eq. 1), and selected based on a comparison of the similarity score of the job title and similarity threshold value (e.g., greater than 80% similarity). The selected semantically similar job titles may be held in memory 512, represented in FIG. 5 as related job titles 512a.

The filtering instructions 506c interact with filtering logic 508c of the processor 508 to perform block 306 of FIG. 3, for example. Specifically, the filtering instructions 506c causes the processor 508 to filter the historical datastore 510a based on at least the experience 512b and the one or more related job titles 512a to obtain a filtered résumé dataset 512c stored in memory 512, as described above with respect to block 306 of method 300.

The user skills selecting instructions 506d interact with user skills selecting logic 508d of the processor 508 to perform block 308 of FIG. 3, for example. The user skills selecting instructions 506d may cause the processor 508 to select one or more skills from the filtered résumé dataset 512c to obtain a list of user skills 512d. In certain embodiments, the list of user skills 512d may include associated prevalence values corresponding to the number of occurrences of each respective user skill in the historical résumé datastore 510a.

The curated skills selecting instructions 506e interact with curated skills selecting logic 508e to perform block 310 of FIG. 3, for example. The curated skills selecting instructions 506e may cause the processor 508 to select one or more curated skills from a curated skills datastore 510b based on at least the experience 512b and the one or more related job titles 512a to obtain a list of curated skills stored in memory 512 as a list of curated skills 512e. In certain embodiments, curated skills selecting instructions 506e may cause the processor 508 to sort the one or more curated skills in the list of curated skills 512e based on the prevalence value of each user skill in the list of user skills 512d.

The skills mapping instructions 506f interact with skills mapping logic 508f to perform block 312 of FIG. 3, for example. The skills mapping instructions 506f may cause the processor 508 to map individual skills from the list of user skills 512d to corresponding curated skills of the list of curated skills 512e to obtain a list of candidate skills 512f. The skills mapping logic 508f may apply text matching, NLP, semantic similarity, rulesets, fuzzy logic, or other appropriate text mapping technique. Additionally, in certain embodiments, the skills mapping instructions 506f may cause the processor 508 to arrange the list of candidate skills 512f as an ordered list based on the prevalence value associated with each respective candidate skill.

The list of candidate skills 512f may be transmitted by the I/O component to the user workstation 514. At the user workstation, the list of candidate skills may be displayed in the UI 100, namely, within the text list box 110. The UI 100 allows the user to select one or more candidate skills, which are then returned to the processing system 502.

The incorporating instructions 506g interact with incorporating logic 508g to perform block 314 of FIG. 3, for example. The incorporating instructions 506g may cause the processor 508 to provide a résumé builder UI, such as UI 600 shown in FIG. 6, allowing a user to select one or more job titles and associated skills for inclusion into a résumé document 518. The incorporating logic 508g may receive the user selections from the résumé builder UI and incorporate the selected job titles and skills into a résumé document 518. Moreover, the incorporating instructions 506g may cause the processor 508 to present the completed résumé to the user in a preview pane, such as preview pane 610 of FIG. 6.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method for generating a résumé, comprising: receiving at least an experience parameter and a job title parameter from a user interface; identifying, using a semantically similar job title selector, one or more related job titles in a historical résumé dataset that are semantically related to the job title parameter; filtering the historical résumé dataset based on at least the experience parameter and the one or more related job titles to obtain a filtered résumé dataset; selecting one or more skills from the filtered résumé dataset to obtain a list of user skills; selecting one or more curated skills from a curated skills dataset based on at least the experience parameter and the one or more related job titles to obtain a list of curated skills; mapping individual skills from the list of user skills to corresponding curated skills of the list of curated skills to obtain a list of candidate skills from among the list of curated skills; and incorporating one or more candidate skills, selected from the list of candidate skills, into a résumé document, using a résumé builder user interface.

Clause 2: The method of Clause 1, further comprising: preparing for presentation on a user interface the list of candidate skills; and receiving, from the user interface, the one or more candidate skills selected from the list of candidate skills.

Clause 3: The method of Clauses 1 or 2, wherein identifying the one or more related job titles further comprises calculating a similarity score based on a Cosine similarity between the job title parameter and each of the job titles in the historical résumé dataset, wherein each of the job titles in the historical résumé dataset with respective similarity scores exceeding a threshold value being selected as the one or more related job titles.

Clause 4: The method of any one of Clauses 1-3, further comprising: generating a count dictionary for each user skill reflecting occurrences of each respective user skill in the historical résumé dataset; and arranging the list of candidate skills as an ordered list based on the count dictionary associated with each respective candidate skill.

Clause 5: The method of any one of Clauses 1-4, further comprising sorting the one or more curated skills in the list of curated skills based on the count dictionary associated with each user skill in the list of user skills and a semantic similarity score indicative of semantic similarity between each of the related job titles and the job title parameter.

Clause 6: The method of any one of Clauses 1-5, wherein the historical résumé dataset includes historical résumés that are at least 80% complete, and have been downloaded at least once.

Clause 7: The method of any one of Clauses 1-6, further comprising: compiling the historical résumé dataset from historical résumés spanning a defined period of time; and implementing a sliding time window having a period of between 1 year and 3 years as the defined period of time for the historical résumé dataset.

Clause 8: A method for generating a résumé, comprising: presenting a user interface having one or more input fields, and one or more output fields; receiving at least an experience parameter and a job title parameter at the one or more input fields of the user interface; transmitting the experience parameter and the job title parameter to a résumé generating service; outputting a list of candidate skills in the one or more output fields of the user interface, the list of candidate skills corresponding to curated skills filtered from a curated skills dataset based on an experience range derived from the experience parameter, and one or more related job titles extracted from a historical résumé dataset, the one or more related job titles being identified as semantically related to the job title parameter; and detecting at least one user action, at the user interface, configured to indicate one or more selected candidate skills selected from the list of candidate skills presented in the one or more output fields; transmitting the one or more selected candidate skills to the résumé generating service; and outputting a résumé document at the user interface, the résumé document being generated based on the one or more selected candidate skills.

Clause 9: The method of Clause 8, further comprising: presenting a set of graphical layout templates; and accepting a selection of a graphical layout template from among the set of graphical layout templates, the résumé document being output with the graphical layout template applied thereto.

Clause 10: The method of Clauses 8 or 9, wherein outputting the résumé document includes presenting a visual representation of the résumé document in a preview area of the user interface.

Clause 11: The method of any one of Clauses 8-10, wherein outputting the résumé document includes implementing an interactive element on the user interface configured to download the résumé document.

Clause 12: The method of any one of Clauses 8-11, wherein each of the one or more related job titles have a similarity score, based on a calculated Cosine similarity between each of the one or more related job titles and the job title parameter, exceeding a threshold value.

Clause 13: The method of any one of Clauses 8-12, wherein the one or more skills in the list of candidate skills are sorted based on an occurrence count for each of the one or more candidate skills reflecting a number of occurrences of the respective skill in the historical résumé dataset and a similarity score indicative of a semantic similarity between each of the one or more related job titles and the job title parameter.

Clause 14: A processing system, comprising: a memory comprising computer-executable instructions; and a processor configured to execute the computer-executable instructions and cause the processing system to perform a method in accordance with any one of Clauses 1-13.

Clause 15: A processing system, comprising means for performing a method in accordance with any one of Clauses 1-13.

Clause 16: A non-transitory computer-readable medium storing program code for causing a processing system to perform the steps of any one of Clauses 1-13.

Clause 17: A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating a résumé, comprising:
receiving at least an experience parameter and a job title parameter from a user interface;
identifying, using a semantically similar job title selector, one or more related job titles in a historical résumé dataset that are semantically related to the job title parameter;
filtering the historical résumé dataset based on at least the experience parameter and the one or more related job titles to obtain a filtered résumé dataset;
selecting one or more skills from the filtered résumé dataset to obtain a list of user skills;
selecting one or more curated skills from a curated skills dataset based on at least the experience parameter and the one or more related job titles to obtain a list of curated skills;
mapping individual skills from the list of user skills to corresponding curated skills of the list of curated skills to obtain a list of candidate skills from among the list of curated skills; and
incorporating one or more candidate skills, selected from the list of candidate skills, into a résumé document, using a résumé builder user interface.

2. The method of claim 1, further comprising:
preparing for presentation on a user interface the list of candidate skills; and
receiving, from the user interface, the one or more candidate skills selected from the list of candidate skills.

3. The method of claim 1, wherein identifying the one or more related job titles further comprises calculating a similarity score based on a Cosine similarity between the job title parameter and each of the job titles in the historical résumé dataset, wherein each of the job titles in the historical résumé dataset with respective similarity scores exceeding a threshold value being selected as the one or more related job titles.

4. The method of claim 1, further comprising:
generating a count dictionary for each user skill reflecting occurrences of each respective user skill in the historical résumé dataset; and
arranging the list of candidate skills as an ordered list based on the count dictionary associated with each respective candidate skill.

5. The method of claim 4, further comprising sorting the one or more curated skills in the list of curated skills based on the count dictionary associated with each user skill in the list of user skills and a semantic similarity score indicative of semantic similarity between each of the related job titles and the job title parameter.

6. The method of claim 1, wherein the historical résumé dataset includes historical résumés that are at least 80% complete, and have been downloaded at least once.

7. The method of claim 1, further comprising:
compiling the historical résumé dataset from historical résumés spanning a defined period of time; and
implementing a sliding time window having a period of between 1 year and 3 years as the defined period of time for the historical résumé dataset.

8. A processing system, comprising:
a memory comprising computer-executable instructions; and
one or more processors configured to execute computer-executable instructions causing the processing system to:
receive at least an experience parameter and a job title parameter;
identify one or more related job titles in a historical résumé dataset that are semantically related to the job title parameter;
filter the historical résumé dataset based on at least the experience parameter and the one or more related job titles to obtain a filtered résumé dataset;
select one or more skills from the filtered résumé dataset to obtain a list of user skills;
select one or more curated skills from a curated skills dataset based on at least the experience parameter and the one or more related job titles to obtain a list of curated skills;
map individual skills from the list of user skills to corresponding curated skills of the list of curated skills to obtain a list of candidate skills from among the list of curated skills; and
incorporate one or more candidate skills, selected from the list of candidate skills, into a résumé document.

9. The processing system of claim 8, further comprising the one or more processors configured to execute computer-executable instructions causing the processing system to:
prepare for presentation on a user interface the list of candidate skills; and
receive, from the user interface, the one or more candidate skills selected from the list of candidate skills.

10. The processing system of claim 8, wherein the computer-executable instructions causing the processing system to identify the one or more related job titles further comprises computer-executable instructions causing the processing system to calculate a similarity score based on a Cosine similarity between the job title parameter and each of the job titles in the historical résumé dataset, wherein each of the job titles in the historical résumé dataset with respective similarity scores exceeding a threshold value being selected as the one or more related job titles.

11. The processing system of claim 8, further comprising the one or more processors configured to execute computer-executable instructions causing the processing system to:
generate a count dictionary for each user skill reflecting occurrences of each respective user skill in the historical résumé dataset; and
arrange the list of candidate skills as an ordered list based on the count dictionary associated with each respective candidate skill.

12. The processing system of claim 11, further comprising the one or more processors configured to execute computer-executable instructions causing the processing system to sort the one or more curated skills in the list of curated skills based on the count dictionary associated with each user skill in the list of user skills and a semantic similarity score indicative of semantic similarity between each of the related job titles and the job title parameter.

13. The processing system of claim 8, wherein the historical résumé dataset includes historical résumés that are at least 80% complete, and have been downloaded at least once.

14. The processing system of claim 8, further comprising the one or more processors configured to execute computer-executable instructions causing the processing system to:
compile the historical résumé dataset from historical résumés spanning a defined period of time; and
implement a sliding time window having a period of between 1 year and 3 years as the defined period of time for the historical résumé dataset.

15. A method for generating a résumé, comprising:
presenting a user interface having one or more input fields, and one or more output fields;
receiving at least an experience parameter and a job title parameter at the one or more input fields of the user interface;
transmitting the experience parameter and the job title parameter to a résumé generating service;
outputting a list of candidate skills in the one or more output fields of the user interface, the list of candidate skills corresponding to curated skills filtered from a curated skills dataset based on an experience range derived from the experience parameter, and one or more related job titles extracted from a historical résumé dataset, the one or more related job titles being identified as semantically related to the job title parameter;
detecting at least one user action, at the user interface, configured to indicate one or more selected candidate skills selected from the list of candidate skills presented in the one or more output fields;
transmitting the one or more selected candidate skills to the résumé generating service; and
outputting a résumé document at the user interface, the résumé document being generated based on the one or more selected candidate skills.

16. The method of claim 15, further comprising:
presenting a set of graphical layout templates; and
accepting a selection of a graphical layout template from among the set of graphical layout templates, the résumé document being output with the graphical layout template applied thereto.

17. The method of claim 15, wherein outputting the résumé document includes presenting a visual representation of the résumé document in a preview area of the user interface.

18. The method of claim 15, wherein outputting the résumé document includes implementing an interactive element on the user interface configured to download the résumé document.

19. The method of claim 15, wherein each of the one or more related job titles have a similarity score, based on a calculated Cosine similarity between each of the one or more related job titles and the job title parameter, exceeding a threshold value.

20. The method of claim 15, wherein one or more candidate skills in the list of candidate skills are sorted based on an occurrence count for each of the one or more candidate skills reflecting a number of occurrences of the respective skill in the historical résumé dataset and a similarity score indicative of a semantic similarity between each of the one or more related job titles and the job title parameter.
